(19) United States
(12) Patent Application Publication
(10) Pub. No.: US 2004/0259048 A1
(43) Pub. Date: Dec. 23, 2004

(54) Orthodontic hook appliance

(76) Inventor: Alexander Balabanovsky, Ashdod (IL)

Correspondence Address: NATH & ASSOCIATES, 1030 15th STREET, NW, 6TH FLOOR, WASHINGTON, DC, 20005, US

(21) Appl. No.: 10/870,046

(22) Filed: Jun. 18, 2004

(30) Foreign Application Priority Data
Jun. 19, 2003 (IL) 156529

(51) Int. Cl. A61C 3/00

(52) U.S. Cl. 433/10; 433/18

(57) ABSTRACT

An orthodontic hook appliance for use with an orthodontic bracket having at least a pair of tie-wings, the appliance comprising an elastic bracket-engaging portion formed with one or more apertures for engagement with the tie-wings, and a hook formed with the elastic bracket-engaging portion.

### FIELD OF THE INVENTION

This invention relates to orthodontic appliances particularly appliances comprising a hook for holding elastics in the mouth of a patient.

### BACKGROUND OF THE INVENTION

Orthodontic appliances comprising hooks are commonly employed for the correction of oral imperfections—usually for holding elastic bands stretched between the teeth of a patient. Presently, the most common methods for locating a hook in a patient's mouth is to install a bracket integrally formed with a hook or to insert and affix on a bracket a ligature wire that is formed (or can be formed) with a hook.

There are a number of drawbacks related to brackets with integral hooks. Unless the bracket is later replaced with a hookless bracket (requiring time and expense) the hook remains in the patient's mouth for the duration of the treatment. This can be uncomfortable for the patient as the hook can scratch or dig in to the gums, lips or cheek. And, if the hooked bracket is removed, but at a later stage of treatment and there is again need for a hook, another time-consuming installation is required. Further, interference by the hook, for example with the gums or adjacent crooked teeth, can prevent the optimal positioning of the bracket on the tooth. Additionally, there is no flexibility (without the time-consuming change-out of brackets) in that during treatment there may arise the need to have an elastic band connected to teeth other than just the teeth originally having brackets with hooks.

U.S. Pat. No. 6,095,808 to Nakagawa discloses an example of a bracket which may have an integrally formed hook—with the added feature of having a relatively inconspicuous material covering or housing on top of the traditional shiny metal base bracket.

The installation of a ligature wire having a hook overcomes the latter issue of flexibility in that the wire can be installed and removed from a tooth after the bracket has been installed. However, it still takes some time to thread or attach the ligature hook-wire via the bracket or arch-wire and to tighten it on the bracket. Then, several twists of the free ends of the hook wire are required in order to tighten it well on the bracket. Further, this twisting often causes the bracket to fall off, requiring additional expense and time to install a new bracket, which requires removal of the arch-wire as well. An example of a ligature wire of this type—having a tendency to cause the bracket to fall off as a result of installation thereon—is described in U.S. Pat. No. 4,522,590 to Pletcher.

In U.S. Pat. No. 4,713,001, to Klein et al, there is disclosed a device that appears to provide an improvement over the above-mentioned hooked bracket and ligature hook-wire, in that it may be attached at any point in the treatment without removing either the bracket or the arch-wire. Also, installation does not require twisting and thus it may be less likely to fell the bracket than the ligature hook-wire. Described is an orthodontic hook device comprising a generally U-shaped wire with a pair of spaced apart legs adapted for selective, removable attachment to orthodontic bracket posts (tie-wings). The U-shaped wire releasably engages the flanges of the bracket posts and comprises projections that can act as hooks for attaching elastic bands. However, after engagement with the bracket, the device requires the device to be secured thereon by two o-ring elastics making the installation a three-step time-consuming process.

Crimpable hooks, which are designed to engage the arch-wire in a non-sliding manner, are also sometimes used to provide elastic band engaging sites. Like the brackets comprising integrally formed hooks, crimpable hooks can also irritate the gums, cheeks, etc., of the patient. Further, such hooks require reinstallation of same each time the arch-wire is replaced.

### SUMMARY OF THE INVENTION

It is thus an object of the present invention to provide an orthodontic hook appliance for deployment on an orthodontic bracket that is quick and easy to install and remove, is inexpensive, does not require removal of the arch-wire or bracket prior to installation or removal thereof, and has a reduced tendency to cause the bracket to fall off as a result of installation thereon.

Accordingly, the present invention relates an orthodontic hook appliance for use with an orthodontic bracket comprising at least a pair of tie-wings said appliance comprising an elastic bracket-engaging portion (BEP) formed with one or more apertures for engagement with said tie-wings, and a hook formed with said elastic bracket-engaging portion (BEP).

In another embodiment of the invention the orthodontic assembly comprises an orthodontic bracket, an arch-wire and a hook appliance comprising an elastic bracket-engaging portion (BEP) formed with at least one aperture for engagement with a pair of tie-wings of the bracket, and a hook formed with said bracket-engaging portion.

### BRIEF DESCRIPTION OF THE DRAWINGS

In order to understand the invention and to see how it may be carried out in practice, some embodiments will now be described, by way of non-limiting examples only, with reference to the accompanying drawings, in which:

FIG. 1A is a perspective view of an orthodontic hook appliance according to an embodiment of the present invention;

FIG. 1B is a perspective view of an alternative orthodontic hook appliance according to an embodiment of the present invention;

FIG. 2 is a perspective view of an orthodontic bracket as known per se;

FIG. 3 is a front view of the orthodontic hook appliance according to the embodiment of FIG. 1 installed on the orthodontic bracket;

FIGS. 4A and 4B are front views of different embodiments of the orthodontic hook appliance of the present invention showing examples of alternately configured and located hooks;

FIG. 5 is a perspective view of an orthodontic hook appliance according to a further embodiment of the present invention comprising projections to help position an orthodontic arch-wire; and

FIGS. 6A and 6B are front views of orthodontic hook appliances according to further embodiments of the present invention illustrating alternate bracket engaging arrangements.

### DETAILED DESCRIPTION OF THE INVENTION

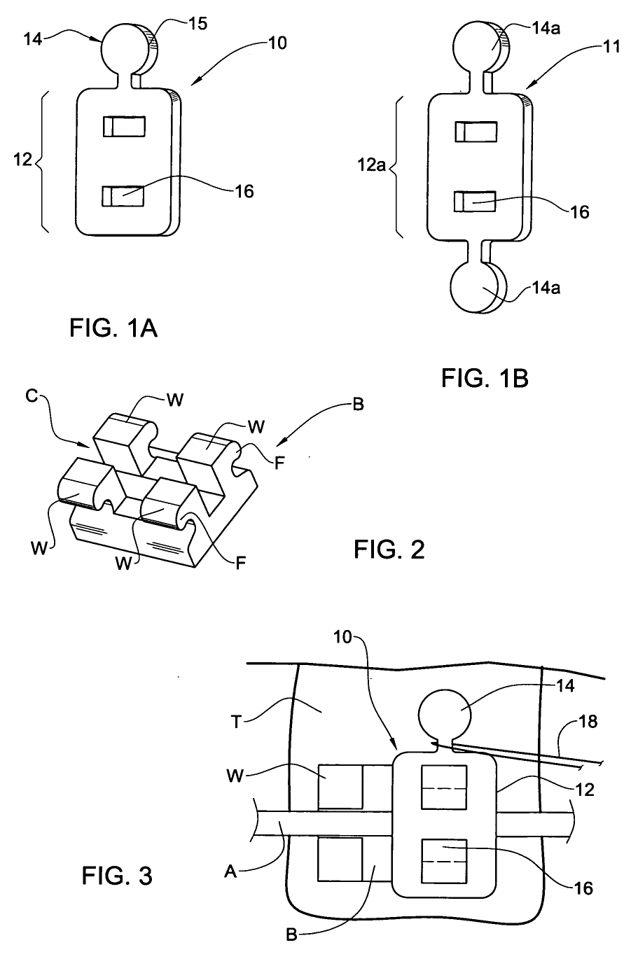

Referring first to FIG. 1A of the drawings, an orthodontic hook appliance, generally designated 10, is shown comprising a bracket-engaging portion (BEP) 12 and a hook 14. The BEP 12, which is made of an elastic material, comprises two apertures 16.

The hook 14 must function to hold an elastic band 18 (FIG. 3) in tension and therefore is typically made of a relatively rigid material. However, the hook 14 may alternatively comprise a stiffening component such as an internal wire (not shown), the wire potentially being partially or significantly embedded into the BEP 12 whereby the BEP and hook can be made of the same material. A further option, which is dependent-on the particular material of manufacture, is that the hook 12 is simply dimensioned to be strong enough to hold the elastic band 18 (FIG. 3) installed thereon. For aiding in securing an elastic band thereon, the hook 14 may comprise a bulge 15 on its free end (FIG. 1A).

FIG. 1B illustrates an orthodontic hook appliance 11, comprising two hooks 14a one being located in an upper position and one in a lower position on a BEP 12a. In such an alternative appliance, an elastic could be attached at either of the hooks 14a.

FIG. 2 illustrates a typical orthodontic bracket B having four tie-wings W defining a channel C in which an arch-wire A is threaded (see FIG. 3), the tie-wings further comprising a flange portion F. Orthodontic brackets are known comprising other than four tie-wings—typically two, if not four—and having a geometry other than that of the bracket B shown in FIG. 2 and it should be understood that the appliance of the present invention is not limited to use with this bracket.

FIG. 3 shows the appliance 10 installed on the bracket B, which is attached to a tooth T. Installation is quick and easy, merely entailing stretching the BEP 12 so that apertures 16 slide over two of the tie-wings W, typically one aperture and then the other, so as to be securely mounted on the bracket B—as a result of the elastic deformation of the BEP and/or the apertures.

The appliance 10 is shown installed over the arch-wire A, however, the appliance may be installed under the arch-wire. The arch-wire A is often replaced during treatment and an installation under the arch-wire will serve to hold the appliance 10 even more securely. To suit such an option, at least the area of the BEP 12 that would lie under the arch-wire A may be made with a narrow profile so as not to provide an in-appropriate bulge under the arch-wire.

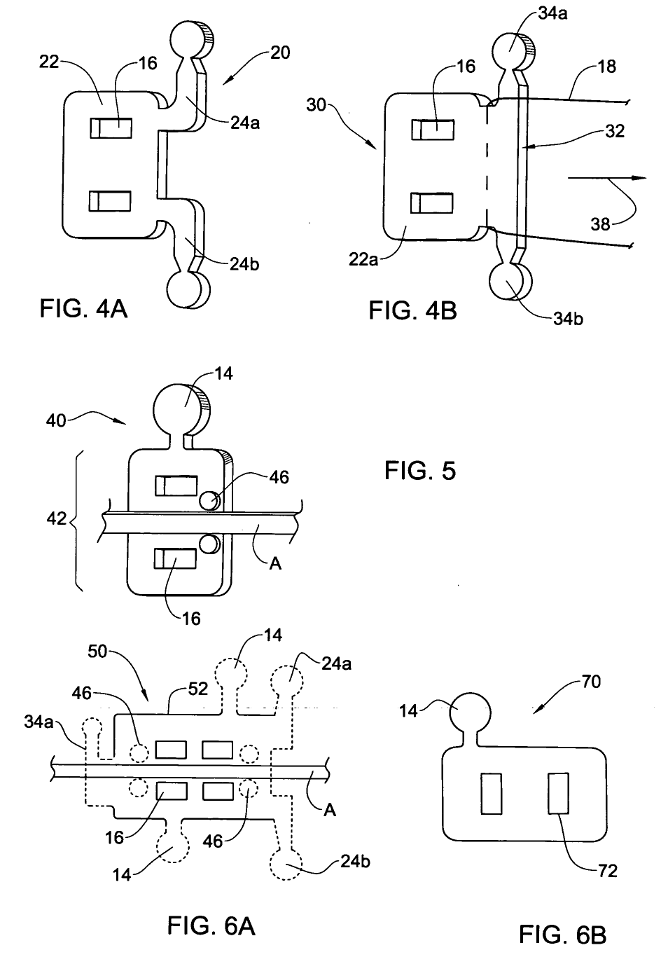

Further embodiments are now illustrated with reference to FIGS. 4 to 6. For the sake of clarity, similar parts in various embodiments of the present invention described hereinafter will be designated with the same reference number.

A modified orthodontic hook appliance 20 is shown in FIG. 4A having a BEP 22 similar to that of FIGS. 1A and 1B, but with a hooks 24a and 24b having different geometry attached thereto. The hooks 24a and 24b are also illustrated being alternately positioned with respect to the BEP 22 as compared to the embodiments of FIGS. 1A and 1B. The appliance 20 could include just one hook, both hooks 24a and 24b or additional hooks—of this nature or of alternative configurations. Further, an elastic could be hooked on just one of the hooks 24a or 24b, or hooked around both (illustrated in FIG. 4B).

In FIG. 4B there is shown a modification to the orthodontic hook appliance shown in FIG. 4A wherein an appliance 30 has a BEP 22a with a modified hook arrangement 32 attached thereto having projections or hooks 34a and 34b. The hooks 34a and 34b are configured in a “dog-bone like” shape as shown, and the elastic band 18 can be threaded in an alternate manner, i.e. around both of the hooks, as shown. This threading may provide a sturdier base for the elastic band 18, especially when it is tensioned in a substantially horizontal direction, i.e. substantially parallel to arrow 38. It should be understood that the elastic band 18 could be threaded about only hook 34a or only hook 34b and that the hook arrangement 32 could include only one of the hooks.

FIG. 5 shows an orthodontic hook appliance 40 illustrating yet further modifications wherein a bracket-engaging portion (BEP) 42 comprises projections 46 between which the arch-wire A is intended to pass. These projections 46 serve to help position and fix the arch-wire A in a proper location in cases where the appliance 40 is installed below the arch-wire.

FIG. 6A illustrates an orthodontic hook appliance 50 having a modified bracket-engaging portion (BEP) 52 comprising, in this exemplification, four apertures 16 for engaging tie-wings W of orthodontic bracket B. Although the time needed for installation would typically be greater than that of the previous embodiments illustrating BEPs with two apertures 16, the installation is very quick and easy and the extra time is negligible. A practitioner of the art should be able to install the appliance of the previous embodiments or of the present embodiment in a matter of seconds. Further, in the present embodiment, the appliance 50 benefits from a stronger engagement with the tie-wings W.

The hooks 14, 24a, 24b and 34a in FIG. 6A are shown with dashed lines to thereby indicate that hooks can be located at various locations and in various locations on the BEP 52—as well as in conjunction with other embodiments herein described and other modifications of BEPs not necessarily exemplified herein. Similarly, projections 46 are shown with dashed lines thereby indicating that projections can be located in various locations on the BEP 52 (or other BEPs) in order to guide/secure the arch-wire A in cases where the arch-wire lies on top of the BEP.

FIG. 6B illustrates a modified hook appliance 70 comprising an alternate aperture 72, that is elongated and which may serve to make installation of an appliance 50 such as that shown in FIG. 6A even easier. As with the above embodiments, the thickness of the BEP 12, 22, 42, 52, 62 can be designed to suit the thickness under the flange portion F of the tie-wings W for improved holding of the appliance on the bracket B.

It should be noted that various components of the orthodontic hook appliance described above, as well as variations thereof are provided merely by way of illustration and are by no means exclusive, and many variations and modifications thereof are possible.

For example, the bracket engaging portions (BEPs) could have three apertures for engagement with the bracket B, or alternately the BEPs could have two apertures arranged diagonally—not side-by-side as described above. In another aperture option, the aperture 46 of FIG. 5 could be used in combination with an appliance engaging all four tie-wings W, the aperture being elongated in either the horizontal or vertical directions.

In another example, the hook(s) could be of various shapes, such as bulbous/spherical and can comprise profiles that are, or are not, of the same thickness as the bracket-engaging portions (BEPs).

It will be appreciated that the above descriptions are intended only to serve as examples, and that many other embodiments are possible within the spirit and scope of the present invention.

1. An orthodontic hook appliance for use with an orthodontic bracket comprising at least a pair of tie-wings said appliance comprising an elastic bracket-engaging portion formed with one or more apertures for engagement with said tie-wings, and a hook formed with said elastic bracket-engaging portion.

2. The orthodontic hook appliance according to claim 1, wherein the bracket-engaging portion is a substantially flat member.

3. The orthodontic hook appliance according to claim 1, wherein the apertures of the bracket engaging portion are sized and spaced apart such that elastic deformation is required for mounting the bracket engaging portion over the tie-wings.

4. The orthodontic hook appliance according to claim 1, wherein the hook is rigid.

5. The orthodontic hook appliance according to claim 4, wherein the hook is at least partially embedded within the bracket-engaging portion.

6. The orthodontic hook appliance according to claim 4, wherein the hook is at is strengthened by a reinforcing component.

7. The orthodontic hook appliance according to claim 1, wherein the hook portion is formed at a free end thereof with a bulge.

8. The orthodontic appliance according to claim 1, wherein the bracket engaging portion is formed with at least a pair of apertures for mounting over tie-wings.

9. The orthodontic hook appliance according to claim 8, wherein the hook symmetrically extends from tie-wings, whereby said appliance may be attached to a front or a rear pair of tie-wings and for projecting said hook upwards or downwards.

10. The orthodontic hook appliance according to claim 8, wherein the bracket-engaging portion is attachable to a pair of tie-wings composed of one upper tie-wing and one lower tie-wing.

11. The orthodontic hook appliance according to claim 8, wherein the bracket-engaging portion is attachable to a pair of upper and/or lower tie-wings.

12. The orthodontic hook appliance according to claim 8, wherein the bracket-engaging portion is formed with four apertures for engagement over tie-wings.

13. The orthodontic hook appliance according to claim 1, comprising at least two hooks.

14. The orthodontic hook appliance according to claim 1, wherein the bracket-engaging portion is suited for arresting an arch-wire between respective tie-wings.

15. An orthodontic assembly comprising:
i) an orthodontic bracket;
ii) an arch-wire;
iii) a hook appliance comprising an elastic bracket-engaging portion formed with at least one aperture for engagement with a pair of tie-wings of the bracket, and a hook formed with said bracket-engaging portion.

16. The orthodontic hook assembly according to claim 15, wherein the hook is rigid.

17. The orthodontic assembly according to claim 15, wherein the bracket engaging portion is suited for arresting the arch-wire between respective tie-wings.

18. The orthodontic assembly according to claim 15, wherein bracket engaging portion is attachable to a pair of two upper or two lower tie-wings.

19. The orthodontic assembly-according to claim 15, wherein the bracket-engaging portion is attachable to a pair of wings constituted by one upper tie-wing and one lower tie-wing.
